(19) United States
(12) Patent Application Publication
(10) Pub. No.: US 2025/0135934 A1
(43) Pub. Date: May 1, 2025

(54) MONITORING SYSTEM, MONITORING DEVICE, AUTONOMOUS TRAVELING VEHICLE, MONITORING METHOD, AND MONITORING PROGRAM

(71) Applicant: DENSO CORPORATION, Kariya-city (JP)

(72) Inventor: KEIGO FUJIMOTO, Kariya-city (JP)

(21) Appl. No.: 19/008,338

(22) Filed: Jan. 2, 2025

Related U.S. Application Data
(63) Continuation of application No. PCT/JP2023/022272, filed on Jun. 15, 2023.

(30) Foreign Application Priority Data
Jul. 5, 2022 (JP) 2022-108579

(51) Int. Cl. B60L 53/36; B60L 53/14; G05D 1/65; G05D 101/00

(52) U.S. Cl. CPC B60L 53/36; B60L 53/14; G05D 1/65; G05D 2101/22

(57) ABSTRACT

A monitoring system, a monitoring device, a monitoring method, an autonomous traveling vehicle, or a non-transitory computer-readable storage medium storing a monitoring program monitors a blind spot area that is a blind spot of a facility user by using a monitoring sensor while the autonomous traveling vehicle is charging in a traveling facility in which the autonomous traveling vehicle travels, and outputs monitoring data for the blind spot area.

### CROSS REFERENCE TO RELATED APPLICATIONS

The present application is a continuation application of International Patent Application No. PCT/JP2023/022272 filed on Jun. 15, 2023, which designated the U.S. and claims the benefit of priority from Japanese Patent Application No. 2022-108579 filed on Jul. 5, 2022. The entire disclosures of all of the above applications are incorporated herein by reference.

### TECHNICAL FIELD

The present disclosure relates to a monitoring technology for monitoring a periphery of an autonomous traveling vehicle.

### BACKGROUND

A monitoring system for monitoring a parking lot has been known. A monitoring system of a comparative example monitors a parking lot using images taken by in-vehicle cameras of parked vehicles that have given permission for the provision of images from their in-vehicle cameras.

### SUMMARY

A monitoring system, a monitoring device, a monitoring method, an autonomous traveling vehicle, or a non-transitory computer-readable storage medium storing a monitoring program monitors a blind spot area that is a blind spot of a facility user by using a monitoring sensor while the autonomous traveling vehicle is charging in a traveling facility in which the autonomous traveling vehicle travels, and outputs monitoring data for the blind spot area.

### BRIEF DESCRIPTION OF THE DRAWINGS

FIG. 1 is a block diagram showing an overall configuration according to a first embodiment.

FIG. 2 is a perspective view showing a configuration of a host autonomous traveling vehicle applied to the first embodiment.

FIG. 3 is a block diagram showing a configuration of a host autonomous traveling vehicle applied to the first embodiment.

FIG. 4 is a block diagram showing a functional configuration of a monitoring system according to a first embodiment.

FIG. 5 is a flowchart showing a monitoring flow according to the first embodiment.

FIG. 6 is a flowchart showing a management flow according to the first embodiment.

FIG. 7 is a flowchart showing a monitoring flow according to the first embodiment.

FIG. 8 is a schematic diagram for illustrating a monitoring flow according to the first embodiment.

FIG. 9 is a schematic diagram for illustrating a monitoring flow according to the first embodiment.

FIG. 10 is a schematic diagram for illustrating a monitoring flow according to the first embodiment.

FIG. 11 is a schematic diagram for illustrating a monitoring flow according to a second embodiment.

### DETAILED DESCRIPTION

With regard to vehicles that can be used for monitoring, in the comparative example, there is no details of circumstances that the vehicles can be used for monitoring in order to make effective use of the vehicles.

One example of the present disclosure provides a monitoring system capable of effectively utilizing an autonomous traveling vehicle for monitoring. Another example of the present disclosure provides a monitoring device capable of effectively utilizing an autonomous traveling vehicle for monitoring. Further, another example of the present disclosure provides an autonomous traveling vehicle capable of being effectively utilized in monitoring. Furthermore, another example of the present disclosure provides a monitoring method capable of effectively utilizing an autonomous traveling vehicle for monitoring. Furthermore, another example of the present disclosure provides a monitoring program capable of effectively utilizing an autonomous traveling vehicle for monitoring.

According to a first example embodiment of the present disclosure, a monitoring system monitors a periphery of a host autonomous traveling vehicle including: a monitoring sensor that monitors an external field; and a battery that supplies power to a drive source. The monitoring system includes a processor configured to: monitor a blind spot area that is a blind spot of a facility user by using the monitoring sensor in the host autonomous traveling vehicle while the host autonomous traveling vehicle is charging in a traveling facility in which the host autonomous traveling vehicle travels; and output monitoring data for the blind spot area.

According to a second example embodiment of the present disclosure, a monitoring device is mounted on a host autonomous traveling vehicle and monitors a periphery of a host autonomous traveling vehicle including: a monitoring sensor that monitors an external field; and a battery that supplies power to a drive source. The monitoring device includes a processor configured to: monitor a blind spot area that is a blind spot of a facility user by using the monitoring sensor in the host autonomous traveling vehicle while the host autonomous traveling vehicle is charging in a traveling facility in which the host autonomous traveling vehicle travels; and output monitoring data for the blind spot area.

According to a third example embodiment of the present disclosure, an autonomous traveling vehicle includes: a monitoring sensor that monitors an external field; a battery that supplies power to a drive source; and a processor configured to: monitor a blind spot area that is a blind spot of a facility user by using the monitoring sensor in the host autonomous traveling vehicle while the host autonomous traveling vehicle is charging in a traveling facility in which the host autonomous traveling vehicle travels; and output monitoring data for the blind spot area.

According to a fourth example embodiment of the present disclosure, a monitoring method is executed by a processor for monitoring a periphery of a host autonomous traveling vehicle including: a monitoring sensor that monitors an external field; and a battery that supplies power to a drive source. The method includes: monitoring a blind spot area that is a blind spot of a facility user by using the monitoring sensor in the host autonomous traveling vehicle while the host autonomous traveling vehicle is charging in a traveling facility in which the host autonomous traveling vehicle travels; and outputting monitoring data for the blind spot area.

According to a fifth example embodiment of the present disclosure, a non-transitory computer-readable storage medium stores a monitoring program comprising instructions executed by a processor for monitoring a periphery of a host autonomous traveling vehicle including: a monitoring sensor that monitors an external field; and a battery that supplies power to a drive source, the instructions causing the processor to: monitor a blind spot area that is a blind spot of a facility user by using the monitoring sensor in the host autonomous traveling vehicle while the host autonomous traveling vehicle is charging in a traveling facility in which the host autonomous traveling vehicle travels; and output monitoring data for the blind spot area.

According to these first to fifth example embodiments, a monitoring sensor of the host autonomous traveling vehicle being charged in the traveling facility can monitor the blind spot area of the facility user. Then, the monitoring data for the blind spot area is output. Therefore, the charging host autonomous traveling vehicle can be utilized in monitoring the blind spot area. Therefore, it may be possible to make effective utilization of the autonomous traveling vehicle.

Hereinafter, embodiments of the present disclosure will be described with reference to the drawings. Elements corresponding to each other among the embodiments are assigned the same numeral and their descriptions may be omitted. When only a part of a component is described in an embodiment, the other part of the component can be relied on the component of a preceding embodiment. Furthermore, in addition to the combination of components explicitly described in each embodiment, it is also possible to combine components from different embodiments, as long as the combination process has no difficulty, even if not explicitly described.

### First Embodiment

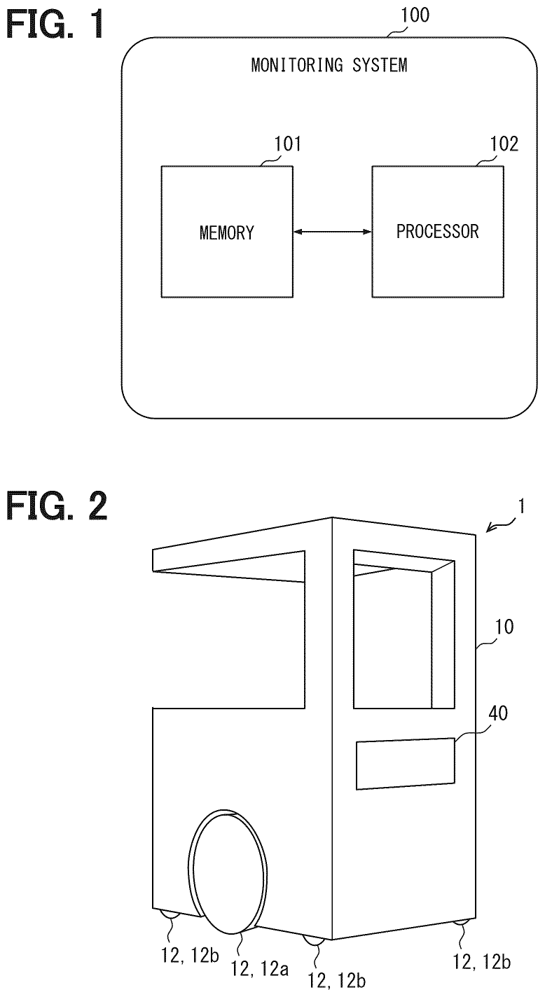

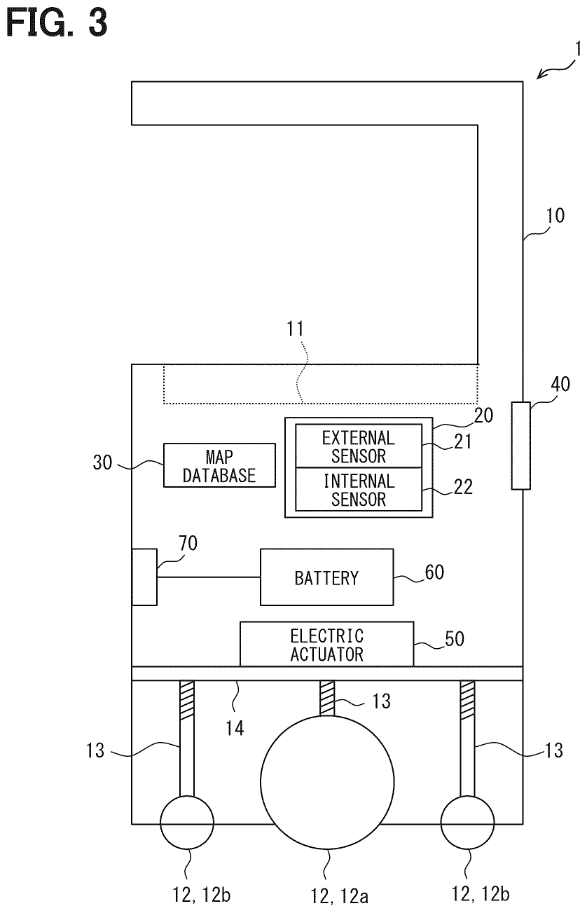

A monitoring system 100 of a first embodiment shown in FIG. 1 executes a process of monitoring the periphery of a host autonomous traveling vehicle 1 transporting a package shown in FIGS. 2 and 3 and a process related to the monitoring process. The host autonomous traveling vehicle 1 autonomously travels in any direction, forward, backward, left or right. The host autonomous traveling vehicle 1 is a logistics vehicle that autonomously travels around mobile facilities such as hospitals and warehouses to transport the package. Alternatively, the host autonomous traveling vehicle 1 may be a delivery vehicle that autonomously travels on roads as a traveling facility to transport a package to a delivery destination. The host autonomous traveling vehicle 1 may be a vehicle other than these, as long as it has the function of transporting the package. Furthermore, whatever type of host autonomous traveling vehicle 1, it may receive remote traveling assistance or traveling control through communication with an external center.

The host autonomous traveling vehicle 1 includes a body 10, a sensor system 20, a map database 30, an information presentation system 40, an electric actuator 50, a battery 60, and a power supply unit 70. The body 10 has a hollow shape, which is made of metal, for example. The body 10 is provided with a package compartment 11 for carrying the package. For example, in this embodiment, the package compartment 11 is formed by being open toward the outside toward the upper part, and being surrounded by the body 10 from the front, rear, left and right sides. The package compartment 11 may have a structure other than that described above.

The body 10 is further provided with wheels 12, a suspension 13, and a mounting plate 14. The wheels 12 include, for example, a drive wheel 12a that is driven by the electric actuator 50 described below, and a driven wheel 12b that rotates in response to the drive wheel 12a. In examples shown in FIGS. 2 and 3, a pair of drive wheels 12a are provided on the left and right sides of the host autonomous traveling vehicle 1. The driven wheels 12b are provided in pairs on the left and right sides in front of and behind the driving wheels 12a, making a total of four wheels. Each wheel 12 is attached via the suspension 13 to the mounting plate 14 that is fixed to the body 10. The air pressure of the drive wheels 12a and the stroke amount of each suspension 13 in a stationary state are adjusted so that the body 10 stands upright with substantially no tilt, at least at the time of shipment.

The sensor system 20 acquires sensing information that can be used by the monitoring system 100 by sensing the external and internal worlds of the host autonomous traveling vehicle 1. For this purpose, the components of the sensor system 20 are mounted at various locations on the body 10. Specifically, the sensor system 20 includes an external sensor 21 and an internal sensor 22.

The external sensor 21 acquires external information as sensing information from the external environment that is the surrounding environment of the host autonomous traveling vehicle 1. The external sensor 21 is an example of a monitoring sensor that monitors the external field. The external sensor 21 may acquire external information by detecting objects present in the external field of the host autonomous traveling vehicle 1. The external sensor 21 of the object detection type is at least one of a camera, a Light Detection and Ranging/Laser Imaging Detection and Ranging (LiDAR), a radar, sonar, and the like, for example. The external sensor 21 is set with a detection direction DA that defines its orientation. The object detection type external sensor 21 is capable of detecting objects within a detection direction DA.

The external sensor 21 may acquire external field information by receiving positioning signals from artificial satellites of GNSS (i.e., Global Navigation Satellite System) disposed in the external field of the host autonomous traveling vehicle 1. The external sensor 21 of a positioning type is, for example, a GNSS receiver or the like. The external sensor 21 may acquire external field information by transmitting and receiving a communication signal to and from a V2X system existing outside the host autonomous traveling vehicle 1. The external sensor 21 of a communication type is, for example, at least one of a DSRC (Dedicated Short Range Communications) communication device, a cellular V2X (C-V2X) communication device, a Bluetooth (registered trademark) device, a Wi-Fi (registered trademark) device, and an infrared communication device, for example. Among communication types, the external sensor 21 of the V2X type in particular may be capable of communicating with at least one type of an external center and another autonomous guided vehicle.

The internal sensor 22 acquires internal field information as sensing information from the internal field, which is the internal environment of the host autonomous traveling vehicle 1. The internal sensor 22 may be of a physical quantity-detecting type which detects a specific physical quantity of motion in the internal field of the host autonomous traveling vehicle 1. The motion detection type internal sensor 22 is, for example, at least one of a traveling speed sensor, an acceleration sensor, a gyro sensor, and the like. The internal sensor 22 may acquire internal filed information by detecting the package on a loading platform in the package compartment 11, which is the internal field of the host autonomous traveling vehicle 1. The package detection type internal sensor 22 is at least one of a weight sensor, a pressure sensor, a camera, and an RFID (Radio Frequency Identifier) reader, for example. The internal sensor 22 may be a charging status detection type that detects the charging status of the battery 60 described later. The battery detection type internal sensor 22 is at least one of a battery remaining amount sensor and a connection sensor that detects the connection state between a charging device C and the power supply unit 70, for example.

The map database 30 stores map information that can be used by the monitoring system 100. The map database 30 includes at least one non-transitory tangible storage medium, such as a semiconductor memory, a magnetic medium, and an optical medium. The map database 30 may be a database of a locator that estimates self-state quantities including the self-position of the host autonomous traveling vehicle 1. The map database 30 may be a database of a planning unit that plans traveling of the host autonomous traveling vehicle 1. The map database 30 may be configured by combining various types of these databases.

The map database 30 acquires and stores the latest map information by, for example, communication with the external center. Here, the map information indicates a traveling environment of the host autonomous traveling vehicle 1, and may be provided by two or three-dimensional data. The map information may include road information indicating at least one of road position, road shape, road surface condition, or the like, for example. The map information may include marking information, which indicates at least one of traffic sign attached to a road, lane mark position, or lane mark shape, for example. The map information may include, for example, structure information indicating at least one of positions or shapes of a building and a traffic light along a road.

The information presentation system 40 presents notification information to a peripheral person in periphery of the host autonomous traveling vehicle 1. The information presentation system 40 may present notification information by stimulating the vision of people in the periphery. The visual stimulation type information presentation system 40 is at least one of a monitor unit or a light emitting unit, for example. The information presentation system 40 may present the notification information by stimulating the hearing of nearby people. The auditory stimulation type information presentation system 40 is, for example, at least one of a speaker, a buzzer, a vibration unit, or the like.

The electric actuator 50 is mounted inside the body 10 and is a drive source that drives the host autonomous traveling vehicle 1 by rotating the drive wheels 12a. The electric actuator 50 mainly includes, for example, individual electric motors corresponding to each of the pair of drive wheels 12a. The electric actuator 50 is capable of independently driving and rotating each of the drive wheels 12a. The electric actuator 50 can switch the drive mode of the host autonomous traveling vehicle 1 between straight-line drive and turning drive by adjusting the rotational speed difference of the drive wheels 12a. The electric actuator 50 may be equipped with a brake unit that applies braking force to each of the drive wheels 12a while they are rotating. The electric actuator 50 may be provided with a lock unit that locks each of the drive wheels 12a when the wheels are stopped.

The battery 60 is mounted within the body 10. The battery 60 mainly includes a storage battery such as a lithium ion battery, for example. The battery 60 stores electric power by charging from an external device and supplies the electric power to electric components in the body 10 by discharging. The battery 60 may store regenerated electric power from the electric actuators 50. The battery 60 is connected via a wire harness to the mounted components of the host autonomous traveling vehicle 1, such as the electric actuator 50, the sensor system 20, the map database 30, and the information presentation system 40, so as to supply power thereto.

The power supply unit 70 is electrically connected to the battery 60. The power supply unit 70 is electrically connected to the external charging device C, and supplies the power supplied from the charging device C to the battery 60. The power supply unit 70 may be configured to be mechanically connected to the charging device C so as to be supplied with power from the charging device C. Alternatively, the power supply unit 70 may be configured to receive power from the charging device C in a contactless manner.

The monitoring system 100 is connected to the sensor system 20, the map database 30, the information presentation system 40, the electric actuator 50, and the battery 60 via at least one of, for example, a LAN (Local Area Network) line, a wire harness, an internal bus, or a wireless communication line. The monitoring system 100 includes at least one dedicated computer.

The dedicated computer constituting the monitoring system 100 may be a planning Electronic Control Unit (ECU) that plans a target trajectory for the host autonomous traveling vehicle 1. The dedicated computer constituting the monitoring system 100 may be a trajectory control ECU that causes the actual trajectory of the host autonomous traveling vehicle 1 to follow the target trajectory. The dedicated computer constituting the monitoring system 100 may be an actuator ECU that controls the electric actuators 50 of the host autonomous traveling vehicle 1.

The dedicated computer constituting the monitoring system 100 may be a sensing ECU that controls the sensor system 20 of the host autonomous traveling vehicle 1. The dedicated computer constituting the monitoring system 100 may be a locator ECU that estimates self-state quantities including the self-position of the host autonomous traveling vehicle 1 based on the map database 30. The dedicated computer that constitutes the monitoring system 100 may be an information presentation ECU that controls the information presentation system 40 of the host autonomous traveling vehicle 1. The dedicated computer constituting the monitoring system 100 may be a computer outside the body 10 constituting, for example, an external center or a mobile terminal capable of communicating via the communication type external sensor 21.

The dedicated computer constituting the monitoring system 100 includes at least one memory 101 and at least one processor 102. The memory 101 is at least one type of non-transitory tangible storage medium, such as a semiconductor memory, a magnetic medium, and an optical medium, for storing, in non-transitory manner, computer readable programs and data. Here, memory may refer to accumulation in which data is retained even when the host autonomous traveling vehicle 1 is turned off, or may refer to temporary storage in which data is erased when the host autonomous traveling vehicle 1 is turned off. The processor 102 includes at least one type of, for example, a CPU (i.e., Central Processing Unit), a GPU (i.e., Graphics Processing Unit), a RISC (i.e., Reduced Instruction Set Computer)—CPU, a DFP (i.e., Data Flow Processor), a GSP (i.e., Graph Streaming Processor), or the like as a core.

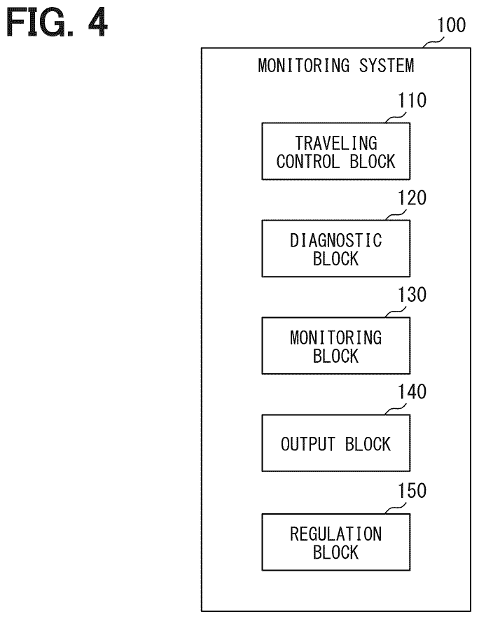

In the monitoring system 100, the processor 102 executes a number of instructions contained in a monitoring program stored in the memory 101 in order to monitor the periphery of the host autonomous traveling vehicle 1. As a result, the monitoring system 100 constructs multiple functional blocks for monitoring the periphery of the host autonomous traveling vehicle 1. The multiple function blocks constructed in the monitoring system 100 include a traveling control block 110, a diagnosis block 120, a monitoring block 130, an output block 140, and a regulation block 150, as shown in FIG. 4.

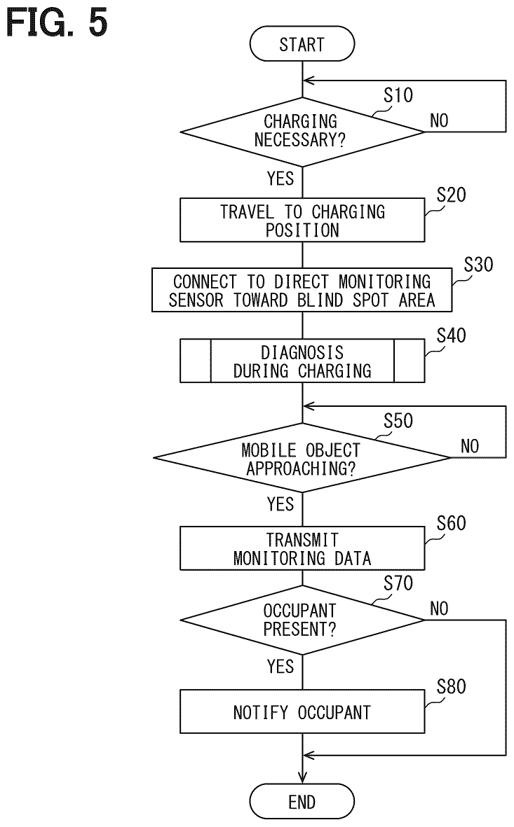

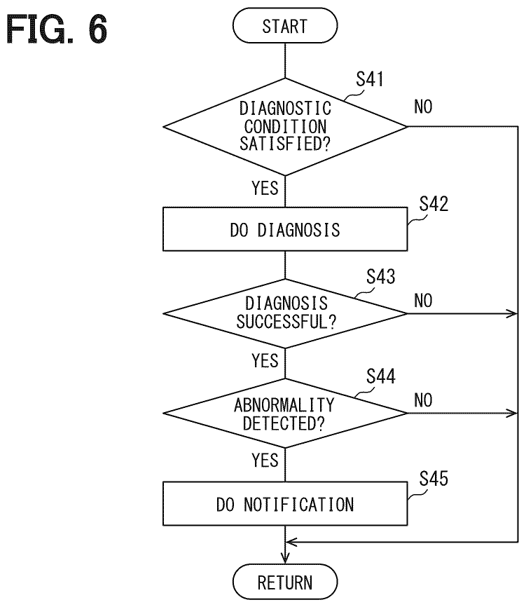

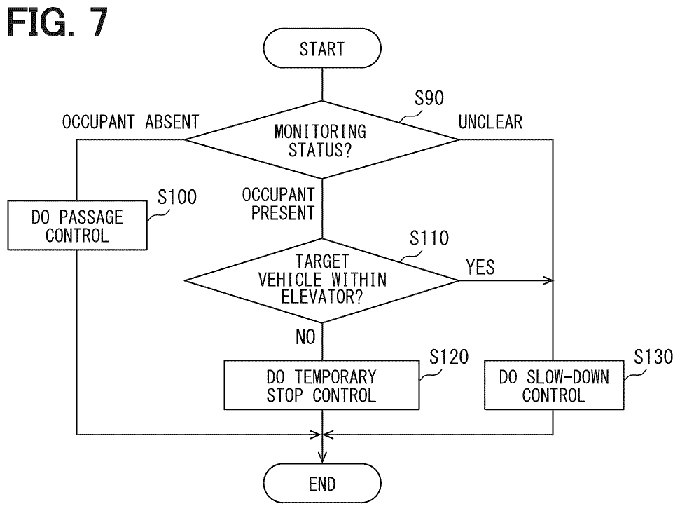

The monitoring method in which the monitoring system 100 monitors the periphery of host autonomous traveling vehicle 1 through cooperation of these blocks 110, 120, 130, 140, and 150 is executed according to the monitoring flows shown in FIGS. 5 to 7. This monitoring flow is executed repeatedly while the host autonomous traveling vehicle 1 is activated. Each “S” in the monitoring flow means multiple processes executed by multiple commands included in a monitoring program. The monitoring flows shown in FIGS. 5 and 6 are executed by, for example, the processor 102 mounted on the host autonomous traveling vehicle 1. Moreover, the monitoring flow shown in FIG. 7 is executed by the processor 102 mounted in a management center that manages the operation of multiple vehicles including, for example, the host autonomous traveling vehicle 1 and a target autonomous traveling vehicle 2.

First, in S10, the traveling control block 110 determines whether charging is required for the host autonomous traveling vehicle 1 that is traveling, based on internal information from the internal sensor 22 of a charging status detection type, etc. When it is determined that charging is not necessary, this flow ends. When it is determined that charging is necessary, the flow proceeds to S20.

In S20, the traveling control block 110 executes traveling control to the charging position where the charging device C is installed, based on information from the map database 30 and the like. When there are multiple charging devices C capable of charging, the traveling control block 110 may select a charging device C capable of monitoring a blind spot area BAa (described later) and cause the vehicle to travel. For example, the traveling control block 110 determines, among unused charging devices C with the current remaining battery charge for enabling the reach, those that are located in positions (monitoring possible positions) where the blind spot area BAa can be monitored and those that are located in positions where the blind spot area BAa cannot be monitored. Then, the traveling control block 110 may preferentially select, as the device to be used, the charging device C located at the monitoring possible position for enabling monitoring of the blind spot area BAa.

In the next S30, the traveling control block 110 performs traveling control to connect the host autonomous traveling vehicle 1, which has traveled to the charging position, to the charging device C with the external sensor 21, which is an object detection type, directed toward the blind spot area BAa. The traveling control block 110 connects to the charging device C, for example, so that the external sensor 21, whose detection direction DA includes the front of the host autonomous traveling vehicle 1, is directed toward the blind spot area BAa. The traveling control block 110 controls the driving of the host autonomous traveling vehicle 1 so as to electrically connect the power supply unit 70 to the charging device C. The power supply unit 70 and the charging device C may be mechanically connected by connectors, or may be electrically connected in a non-contact manner by bringing a power transmitting coil and a power receiving coil into close proximity to each other, which realizes wireless power supply.

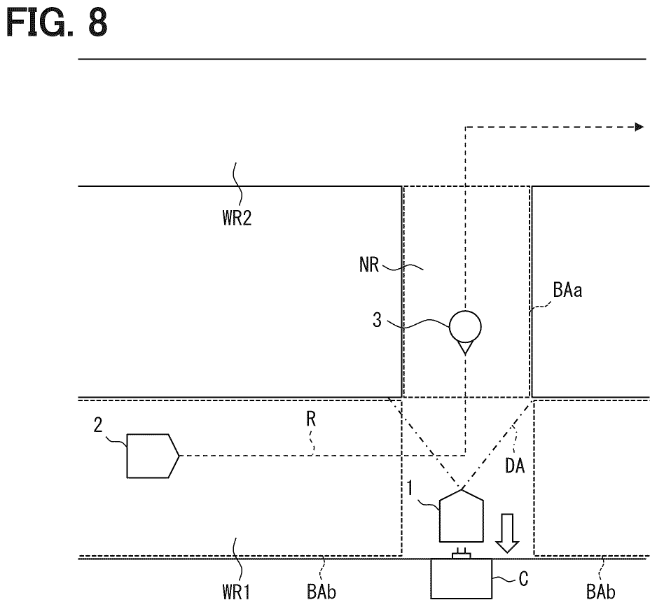

The blind spot area BAa for the external sensor 21 of the host autonomous traveling vehicle 1 connected to the charging device C is determined by the positional relationship with the charging device C. For example, in the example shown in FIG. 8, the blind spot area BAa is a narrow road NR serving as a traveling facility that connects two wide roads WR1, WR2 and is narrower than the wide roads WR1, WR2. It is assumed that the wide roads WR1, WR2 and the narrow road NR are partitioned by walls or the like, and facility users on the wide roads WR1, WR2 and the narrow road NR cannot see each other. In addition, the narrow road NR is narrow enough that it is difficult for the autonomous traveling vehicle and a person to pass each other, and the autonomous traveling vehicle travels in the center of the narrow road NR. The charging device C is provided in the extension direction of the narrow road NR so as to enable charging of the host autonomous traveling vehicle 1 with the narrow road NR ahead.

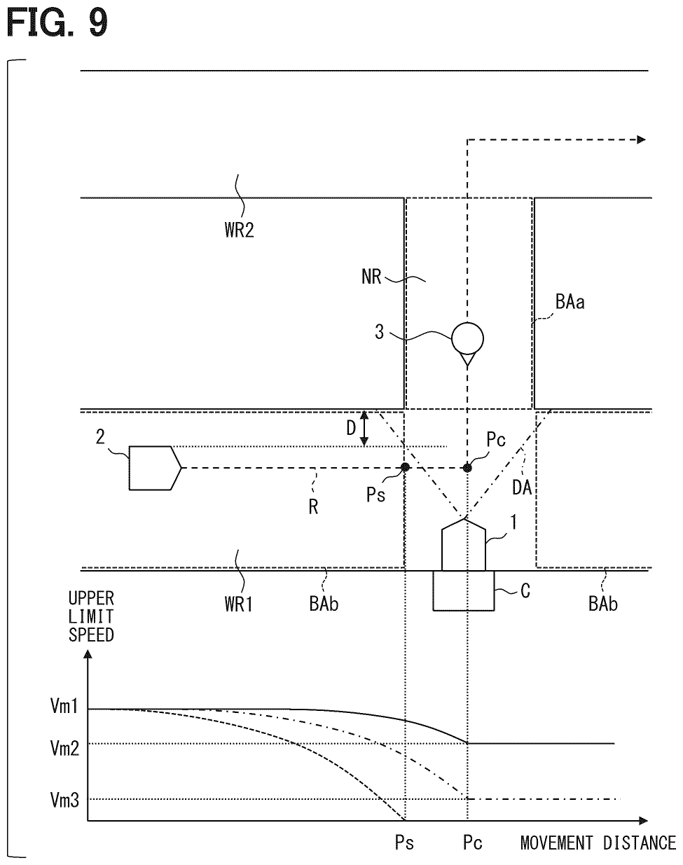

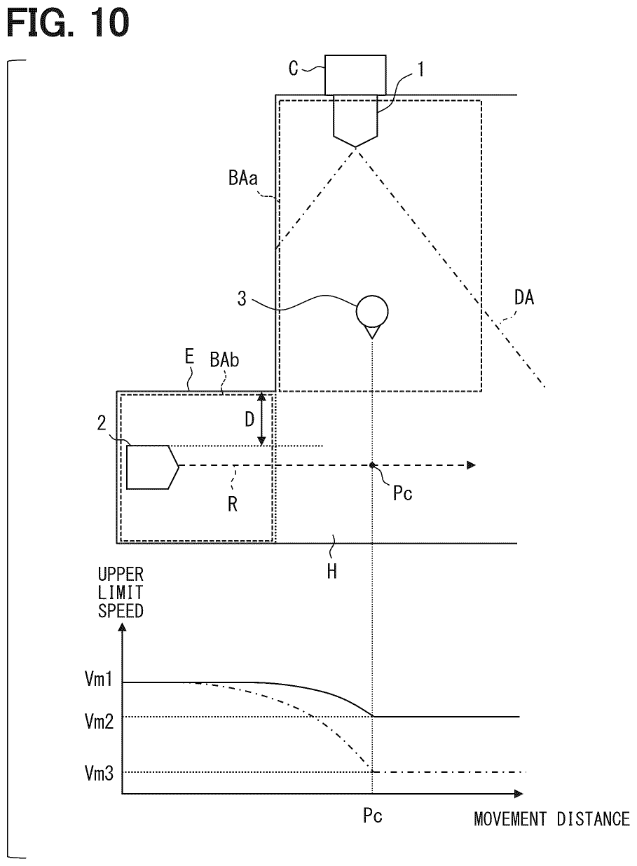

Alternatively, in the example shown in FIG. 10, the blind spot area BAa is an area that is a blind spot from an elevator E, which is a traveling facility, and an elevator hall H, which is also a traveling facility connected to the elevator E. The charging device C is provided at the opposite position to the area near the entrance of the elevator E in the elevator hall H, so that the external sensor 21 is directed toward the area near the entrance. Incidentally, the blind spot area BAa may be determined geometrically in accordance with the structure of the travel facility, as shown in FIG. 9 and FIG. 10. Alternatively, the blind spot area BAa may be determined taking into consideration the detection direction DA of the external sensor 21 of the target autonomous traveling vehicle 2 described later.

The traveling control block 110 in S30 controls traveling so as to electrically connect the power supply unit 70 to these charging devices C. Thereby, the external sensor 21 is directed toward the blind spot area BAa even during charging. As shown in FIG. 8, the blind spot area BAa that can be monitored by the external sensor 21 includes a blind spot area BAb that is a blind spot from facility users in the blind spot area BAa. Incidentally, like the blind spot area BAa, the blind spot area BAb may be determined geometrically in accordance with the structure of the travel facility, or may be determined taking into consideration the vision of facility users and the like.

Next, in S40, the diagnosis block 120 and the output block 140 execute a diagnosis process during charging to monitor the host autonomous traveling vehicle 1 for an abnormality in the height position during charging. The detailed process of S40 will be described with reference to FIG. 6.

First, in S41, the diagnosis block 120 determines whether a diagnosis condition for the host autonomous traveling vehicle 1 is satisfied. For example, a diagnostic condition is determined to be satisfied when all of multiple sub-conditions are satisfied. One of the sub-conditions is, for example, that the host autonomous traveling vehicle 1 has completed connection to the charging device C and is currently charging. Another sub-condition is, for example, that the vehicle is stopped. Yet another sub-condition is that the charging position is one for which comparison information exists. Here, the comparison information is a previously obtained detection result that is compared with the detection result described below. Yet another sub-condition is that the inclination of the charging position is within an allowable range. Yet another sub-condition is that the package does not exist.

When it is determined that the diagnostic condition is not satisfied, this flow ends, and the process returns to the flow of FIG. 5 with the diagnosis interrupted. On the other hand, when it is determined that the diagnostic condition is satisfied, the flow proceeds to S42.

In S42, the diagnosis block 120 executes a diagnosis process to monitor an abnormality in at least one of the height position or attitude of the host autonomous traveling vehicle 1. In the diagnosis process, the diagnosis block 120 detects at least one of the self-position or attitude of the host autonomous traveling vehicle 1 using the sensor system 20. For example, the diagnosis block 120 detects its own position including at least the height by utilizing simultaneous localization and mapping (SLAM) or satellite positioning by the external sensor 21. In addition, the diagnosis block 120 detects the attitude including at least pitch angle information by using information from the SLAM and pitch angle sensor. When information from the pitch angle sensor is used, the internal sensor 22 is also included in the monitoring sensors for the abnormality monitoring.

In the next S43, the diagnosis block 120 determines whether the diagnosis process in S42 was successful. The diagnosis block 120 determines that the diagnostic process is successful when the diagnostic condition remains satisfied until the end of the diagnostic process, and determines that the diagnostic process is unsuccessful when the diagnostic condition no longer remains satisfied midway through the process. When it is determined that the diagnostic process was unsuccessful, this flow ends. On the other hand, when it is determined that the diagnostic process was successful, the flow proceeds to S44.

In S44, the diagnosis block 120 determines from the diagnosis result whether an abnormality has been detected with respect to at least one of the height and pitch angle related to the host autonomous traveling vehicle 1. The diagnosis block 120 determines whether the abnormality has been detected by comparing the height and pitch angle with the respective comparison information. For example, the diagnosis block 120 determines that an abnormality has been detected for the parameters of height and pitch angle, for which the magnitude of the difference from the comparison information is outside the allowable range. When it is determined that no abnormality has been detected, this flow ends. On the other hand, when it is determined that the abnormality has been detected, the flow proceeds to S45. In S45, the output block 140 notifies the management center of information regarding the abnormality. This notification corresponds to the output of monitoring data regarding the abnormality.

Returning to FIG. 5, in S50, the monitoring block 130 determines whether the target autonomous traveling vehicle 2, which is another autonomous traveling vehicle as the facility user, is approaching the blind spot area BAa being monitored by the external sensor 21, which is an object detection type. The monitoring block 130 determines the approach by acquiring approach information on the target autonomous traveling vehicle 2 from a management center, for example, by the communication-type external sensor 21. Alternatively, the monitoring block 130 may obtain approach information directly from the target autonomous traveling vehicle 2 via the external sensor 21 of a communication type. When a person being as the facility user is present in the blind spot area BAa, this approach information corresponds to monitoring data of the blind spot area BAb with respect to the person. In S50, the process waits until it is determined that the target autonomous traveling vehicle 2 is approaching.

When it is determined that the target autonomous traveling vehicle 2 is approaching, the flow proceeds to S60. In S60, the output block 140 outputs monitoring data relating to the blind spot area BAa. Specifically, the output block 140 transmits the monitoring data to a management center that manages the operation of the autonomous traveling vehicle. Alternatively, the output block 140 may transmit the monitoring data directly to the target autonomous traveling vehicle 2. The monitoring data includes at least information related to the presence or absence of an occupant 3 in the blind spot area BAa, that is, a person as the facility user in the blind spot area BAa.

Next, in S70, the monitoring block 130 determines from the monitoring data whether the person as the facility user is present in the blind spot area BAa. When it is determined that the person does not exist, this flow ends. On the other hand, when it is determined that the person is present, the flow proceeds to S80.

In S80, the output block 140 notifies the person via the information presentation system 40 of the host autonomous traveling vehicle 1. The output block 140 notifies information regarding the approach of the target autonomous traveling vehicle 2 through at least one type of information presentation system 40 of a visual stimulation type or an auditory stimulation type. For example, when the person is approaching the host autonomous traveling vehicle 1, it is desirable for the output block 140 to provide a notification using the visual stimulation type information presentation system 40 and not use the auditory stimulation type information presentation system 40. The notification to the person in S80 corresponds to “output of monitoring data” similar to the transmission of the monitoring data in S60.

Next, processes using monitoring data for the target autonomous traveling vehicle 2 approaching a blind spot area BAa will be described with reference to FIG. 7.

First, in S90, the regulation block 150 determines the monitoring situation according to the monitoring data. Specifically, the regulation block 150 determines whether the occupant 3 is present in the blind spot area BAa, whether the occupant 3 is not present, or whether the presence or absence is unclear from the monitoring data.

When it is determined that there is no occupant 3, then in S100, the regulation block 150 regulates an upper passing speed Vm2 for the upper speed limit of the target autonomous traveling vehicle 2 in the periphery of the blind spot area BAa. The passing upper limit speed Vm2 is a speed lower than a normal upper limit speed Vm1. Here, when a maximum deceleration amax of the target autonomous traveling vehicle 2, a projecting distance from the blind spot area BAa is D, the maximum speed Vmax expected of the occupant 3, and a system delay time Td, the upper passing speed Vm2 is defined as the speed that satisfies the relationship of the following first mathematical expression. The projecting distance D is a distance from the blind spot area BAa to the host autonomous traveling vehicle 1 when it is assumed that the host autonomous traveling vehicle 1 is present at an assumed contact position Pc, which will be described later. As shown in FIG. 9, in the case of a facility structure in which the wide road WR1 and the narrow road NR intersect perpendicularly, the protrusion distance D is the distance between the wall of the wide road WR1 close to the narrow road NR and the side of the host autonomous traveling vehicle 1 on the side of that wall. Furthermore, the maximum deceleration amax is the deceleration that can be output at the performance limit of the target autonomous traveling vehicle 2.

$$Vm 2 \leq a max ( D / V max - Td ) \qquad ( First Expression )$$

The upper passing speed Vm2 is set to the upper limit speed after the assumed contact position Pc when it is assumed that the occupant 3 is present. That is, as shown in FIG. 9, the upper limit speed is reduced from the normal upper limit speed Vm1 to the passing upper limit speed Vm2 before arriving at the assumed contact position Pc. The assumed contact position Pc is a position of the host autonomous traveling vehicle 1 at which contact with the occupant 3 is assumed when the occupant 3 were exit the blind spot area BAa. The assumed contact position Pc is, for example, the intersection position between the assumed travel path of the occupant 3 and the planned travel route R of the host autonomous traveling vehicle 1. The expected travel route of the occupant 3 may be set according to the shape of the blind spot area BAa, or according to the expected or detected position and travel direction of the occupant 3. In addition, in FIG. 9, a planned traveling route R for the host autonomous traveling vehicle 1 is a route that proceeds from the wide road WR1 through the narrow road NR to the wide road WR2, but the upper limit speed is similarly specified even when the route proceeds straight along the wide road WR1.

On the other hand, when it is determined in S90 that the occupant 3 is present, the flow proceeds to S110. In S110, the regulation block 150 determines whether the target autonomous traveling vehicle 2 is in the elevator E. When it is determined that the target autonomous traveling vehicle 2 is not inside the elevator E, then in S120, the regulation block 150 regulates a temporary stop control for the traveling of the target autonomous traveling vehicle 2. Specifically, in the temporary stop control, the upper limit speed of the target autonomous traveling vehicle 2 is reduced from the normal upper limit speed Vm1 as it approaches a temporary stop position Ps, so that the target autonomous traveling vehicle 2 stops at the temporary stop position Ps. The temporary stop position Ps is a position Ps defined by the blind spot area BAa, and is a position at which the target autonomous traveling vehicle 2 does not exit toward the blind spot area BAa. For example, the temporary stop position Ps is set to be an end position of the blind spot area BAb.

When it is determined in S90 that the presence or absence of the occupant 3 is unclear, or when it is determined in S110 that the target autonomous traveling vehicle 2 is inside the elevator E, the regulation block 150 regulates slow-down control in S130. In the slow-down control, the regulation block 150 sets a slow movement speed Vm3 as the upper limit speed of the target autonomous traveling vehicle 2 in the periphery of the blind spot area BAa. The slow movement speed Vm3 is lower than the normal upper limit speed Vm1 and the passing upper limit speed Vm2. Here, when the assumed deceleration speed of the target autonomous traveling vehicle 2 is a, a distance projecting from the blind spot area BAa is D, the maximum speed of the occupant 3 is Vmax, and a system delay time is Td, the slow movement speed Vm3 is defined as a speed that satisfies the relationship in the following second expression. Here, the assumed deceleration speed a is a value defined as a deceleration that, when stopping at the assumed contact position Pc, does not cause discomfort to facility users such as following pedestrians and reduce the waver of package.

$$Vm 3 \leq a ( D / V max - Td ) \qquad ( Second Expression )$$

The slow movement speed Vm3 is set to the upper limit speed after the assumed contact position Pc, which is a position where contact with the occupant 3 is assumed when it is assumed that the occupant 3 is present. That is, as shown in FIG. 9, the upper limit speed is reduced from the normal upper limit speed Vm1 to the slow movement speed Vm3 by the time the vehicle arrives at the assumed contact position Pc.

According to the first embodiment described above, the external sensor 21 of the host autonomous traveling vehicle 1 being charged in a traveling facility can monitor the blind spot areas BAa, BAb of the facility user. Then, the monitoring data for the blind spot areas BAa and BAb is output. Therefore, the host autonomous traveling vehicle 1 during charging can be utilized in monitoring the blind spot areas BAa, BAb. Therefore, it may be possible to effectively utilize the host autonomous traveling vehicle 1.

Alternatively, according to the first embodiment, the battery 60 of the host autonomous traveling vehicle 1 is charged so that the external sensor 21 capable of detecting an object in the outside filed is directed toward the blind spot area BAa. Therefore, the blind spot area BAa can be reliably monitored by the object detection type external sensor 21.

Furthermore, according to the first embodiment, the host autonomous traveling vehicle 1 is driven by itself to a charging position where the battery 60 can be charged by the external charging device C. Thereby, the battery 60 is electrically connected to the charging device C. Therefore, the host autonomous traveling vehicle 1 can reliably travel autonomously so that the external sensor 21 can monitor the blind spot area BAa while charging.

In addition, according to the first embodiment, the blind spot area BAa of the target autonomous traveling vehicle 2, which is another autonomous traveling vehicle, is monitored. Therefore, the target autonomous traveling vehicle 2 can travel autonomously while acquiring information about its own blind spot area BAa from the monitoring data.

Alternatively, according to the first embodiment, the monitoring data is transmitted to a management center that manages the host autonomous traveling vehicle 1 and the target autonomous traveling vehicle 2. Therefore, by the management center, operation management that takes into account the blind spot area BAa of the target autonomous traveling vehicle 2 can be implemented.

Furthermore, according to the first embodiment, an upper limit speed of the target autonomous traveling vehicle 2 is defined according to the monitoring status of the blind spot area BAa based on the monitoring data. Therefore, depending on the monitoring status of the blind spot area BAa, it is possible to implement traveling control of the target autonomous traveling vehicle 2 with improved safety.

In addition, according to the first embodiment, the blind spot area BAb of persons as facility users is monitored. Therefore, monitoring data regarding the person blind spot area BAb may be output.

Alternatively, according to the first embodiment, an alert is issued to a person in the blind spot area BAa of the target autonomous traveling vehicle 2 as another facility user. Therefore, it may be possible to warn the person of the presence of the target autonomous traveling vehicle 2 in a blind spot.

Furthermore, according to the first embodiment, the external sensor 21 in the host autonomous traveling vehicle 1 while it is being charged in the traveling facility monitors the abnormality in at least one of the height position or attitude of the host autonomous traveling vehicle 1. Therefore, it is possible to monitor the abnormality in at least one of the height position or the attitude by utilizing the charging status.

### Second Embodiment

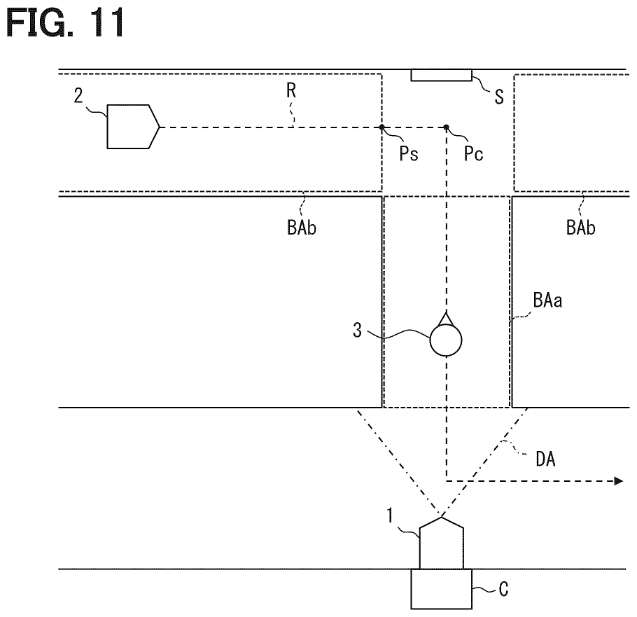

A second embodiment shown in FIG. 11 is a modification of the first embodiment. In the second embodiment, an external information presentation device S is provided at the opposite position to the charging device C with respect to the blind spot area BAa in the travel facility. The external information presentation device S is provided outside the host autonomous traveling vehicle 1 and is an information presentation device that presents notification information to the peripheral person. For example, the external information presentation device S is capable of presenting information at least through visual stimulation, such as digital signage. The external information presentation device S is able to communicate with the host autonomous traveling vehicle 1 directly, or indirectly via a management center or the like. Thereby, it is possible to perform the external information presentation device S to execute notification in response to a notification instruction from the host autonomous traveling vehicle 1.

In the second embodiment, in S80, the output block 140 selectively executes notification by the information presentation system 40 of the host autonomous traveling vehicle 1 and notification by the external information presentation device S. Specifically, when the assumed contact position Pc between the occupant 3 and the target autonomous traveling vehicle 2 is located closer to the host autonomous traveling vehicle 1 than the occupant 3, as shown in FIG. 8, the output block 140 executes notification via the information presentation system 40, as in the first embodiment. Then, when the assumed contact position Pc between the occupant 3 and the target autonomous traveling vehicle 2 is located at the opposite position to the host autonomous traveling vehicle 1 with respect to the occupant 3, as shown in FIG. 11, the output block 140 executes notification by the external information presentation device S by transmitting a notification instruction. In other words, when the occupant 3 is in a situation where the occupant cannot see the visual stimulation type information presentation system 40 in the host autonomous traveling vehicle 1, the output block 140 executes notification by the external information presentation device S.

### Other Embodiment

Although multiple embodiments have been described above, the present disclosure is not construed as being limited to those embodiments, and can be applied to various embodiments and combinations within a scope that does not depart from the spirit of the present disclosure.

In another modification, a dedicated computer constituting the monitoring system 100 may include at least one of a digital circuit or an analog circuit, as a processor. The digital circuit is at least one type of, for example, an application specific integrated circuit (i.e., ASIC), a field programmable gate array (i.e., FPGA), a system on a chip (i.e., SOC), a programmable gate array (i.e., PGA), a complex programmable logic device (i.e., CPLD), and the like. The digital circuit may include a memory storing a program.

The monitoring system 100 according to the embodiments and modifications described above may be implemented as a control device that is configured to be mountable on the host autonomous traveling vehicle 1 and has at least one processor 102 and at least one memory 101. Specifically, the above-described embodiment and modifications may be implemented in the form of a processing circuit (for example, a processing ECU) or a semiconductor device (for example, a semiconductor chip).

What is claimed is:

1. A monitoring system for monitoring a periphery of a host autonomous traveling vehicle including: a monitoring sensor that monitors an external field; and a battery that supplies power to a drive source, the system comprising a processor configured to:
monitor a blind spot area that is a blind spot of a facility user by using the monitoring sensor in the host autonomous traveling vehicle while the host autonomous traveling vehicle is charging in a traveling facility in which the host autonomous traveling vehicle travels; and
output monitoring data for the blind spot area.

2. The monitoring system according to claim 1, wherein
the processor is further configured to cause the battery in the host autonomous traveling vehicle to be charged to direct the monitoring sensor capable of detecting an object in the external field toward the blind spot area.

3. The monitoring system according to claim 2, wherein
charging the host autonomous traveling vehicle includes electrically connecting the host autonomous traveling vehicle to an external charging device by causing the host autonomous traveling vehicle to perform self-traveling to a charging position where the battery is charged by an external charging device.

4. The monitoring system according to claim 1, wherein
monitoring the blind spot area includes monitoring the blind spot area of a target autonomous traveling vehicle that is different from the autonomous traveling vehicle.

5. The monitoring system according to claim 4, wherein
outputting the monitoring data includes transmitting the monitoring data to a management center that manages the host autonomous traveling vehicle and the target autonomous traveling vehicle.

6. The monitoring system according to claim 4, wherein
the processor is further configured to regulate an upper limit speed of the target autonomous traveling vehicle depending on a monitoring status of the blind spot area by the monitoring data.

7. The monitoring system according to claim 1, wherein
monitoring the blind spot area includes monitoring the blind spot area of a person that is the facility user.

8. The monitoring system according to claim 7, wherein
outputting the monitoring data includes executing an alert to the person in the blind spot area of a target autonomous traveling vehicle that is a different facility user.

9. The monitoring system according to claim 1, wherein
the processor is further configured to cause the monitoring sensor in the host autonomous traveling vehicle being charged in the traveling facility to monitor at least one of an abnormality in a height position or an attitude of the host autonomous traveling vehicle,
outputting the monitoring data includes outputting the monitoring data for the abnormality.

10. A monitoring device that is mounted on a host autonomous traveling vehicle and monitors a periphery of a host autonomous traveling vehicle including: a monitoring sensor that monitors an external field; and a battery that supplies power to a drive source, the monitoring device comprising a processor configured to:
monitor a blind spot area that is a blind spot of a facility user by using the monitoring sensor in the host autonomous traveling vehicle while the host autonomous traveling vehicle is charging in a traveling facility in which the host autonomous traveling vehicle travels; and
output monitoring data for the blind spot area.

11. An autonomous traveling vehicle comprising:
a monitoring sensor that monitors an external field;
a battery that supplies power to a drive source; and
a processor configured to:
monitor a blind spot area that is a blind spot of a facility user by using the monitoring sensor while the autonomous traveling vehicle is charging in a traveling facility in which the autonomous traveling vehicle travels; and
output monitoring data for the blind spot area.

12. A monitoring method executed by a processor for monitoring a periphery of a host autonomous traveling vehicle including: a monitoring sensor that monitors an external field; and a battery that supplies power to a drive source, the method comprising:
monitoring a blind spot area that is a blind spot of a facility user by using the monitoring sensor in the host autonomous traveling vehicle while the host autonomous traveling vehicle is charging in a traveling facility in which the host autonomous traveling vehicle travels; and
outputting monitoring data for the blind spot area.

13. A non-transitory computer-readable storage medium storing a monitoring program comprising instructions executed by a processor for monitoring a periphery of a host autonomous traveling vehicle including: a monitoring sensor that monitors an external field; and a battery that supplies power to a drive source, the instructions causing the processor to:
monitor a blind spot area that is a blind spot of a facility user by using the monitoring sensor in the host autonomous traveling vehicle while the host autonomous traveling vehicle is charging in a traveling facility in which the host autonomous traveling vehicle travels; and
output monitoring data for the blind spot area.
